(19) United States
(12) Patent Application Publication
(10) Pub. No.: US 2008/0270287 A1
(43) Pub. Date: Oct. 30, 2008

(54) METHOD AND SYSTEM FOR DEVELOPING A QUALITY INDEX FUND OF SECURITIES

(75) Inventors: Jason D. Pride, St. Davids, PA (US); George W. Connell, Haverford, PA (US); Timothy A. Hoyle, Exton, PA (US); Joseph J. McLaughlin, Media, PA (US); Henry B. Smith, Haverford, PA (US)

Correspondence Address: PEPPER HAMILTON LLP, ONE MELLON CENTER, 50TH FLOOR, 500 GRANT STREET, PITTSBURGH, PA, 15219, US

(73) Assignee: THE HAVERFORD TRUST COMPANY, Radnor, PA (US)

(21) Appl. No.: 12/108,844

(22) Filed: Apr. 24, 2008

Related U.S. Application Data
(60) Provisional application No. 60/913,592, filed on Apr. 24, 2007.

(51) Int. Cl. G06Q 40/00

(52) U.S. Cl. 705/37; 705/35

(57) ABSTRACT

A method of creating an index fund, the method may include selecting, via a computing device, a plurality of candidate securities. Each candidate security may have a quality rating that meets or exceeds a rating threshold. A dividend payment for each candidate security may be accessed. A computer-generated rank may be automatically assigned to each of the candidate securities. The rank may be based on the dividend payment for each candidate security. The candidate securities may be ranked from highest to lowest. A subset may be selected including the highest ranked candidate securities. A computer-generated weight for each security in the subset may be determined by dividing the dividend payment for each security by a total dividend payment for all of the securities in the subset. An index fund may be created including the weighted securities.

### RELATED APPLICATIONS AND CLAIM OF PRIORITY

This patent application claims priority to U.S. Provisional Patent No. 60/913,592, entitled “Method and System for Developing a Quality Index Fund of Securities,” filed on Apr. 24, 2007.

Not Applicable

### BACKGROUND

Various methods are known for creating a stock portfolio or index fund of stocks and/or other securities. Investment managers may create different sets of indices to assist in determining what stocks to place in a portfolio. Financial services companies such as Standard and Poors (S&P), Value Line, Fitch Ratings, Ltd., Morningstar and Moody's Corporation rank or rate stocks and other securities. There are also many computer automated tools which incorporate ratings and/or other evaluations to determine which stocks to place in a portfolio.

For example, U.S. Pat. No. 6,484,152, the disclosure of which is herein incorporated by reference, discloses a method of creating a portfolio based on characteristics which are important to the user. The user may select what characteristics of a stock are important, such as dividends, rate of growth and/or earnings. However, despite methods such as this, investors are constantly seeking funds that implement new and improved methods of selection and weighting of securities.

### SUMMARY

In an embodiment, a method of creating an index fund may include selecting, via a computing device, a plurality of candidate securities, wherein each candidate security has a quality rating that meets or exceeds a rating threshold. A dividend payment for each candidate security may be accessed. A computer-generated rank may be automatically assigned to each of the candidate securities. The rank may be based on the dividend payment for each candidate security. The candidate securities may be ranked from highest to lowest. A subset may be selected including the highest ranked candidate securities. A computer-generated weight for each security in the subset may be determined by dividing the dividend payment for each security by a total dividend payment for all of the securities in the subset. An index fund may be created including the weighted securities.

In an embodiment, after a time period, a new computer-generated weight for each security in the subset may be automatically determined by dividing each security's then-current dividend payment by a total then-current dividend payment for all of the securities in the subset. The index fund may be rebalanced to match the new weight for each security. In an embodiment, rebalancing may include automatically buying and/or selling the securities in accordance with the new weights. In an embodiment, the total dividend payment may include a sum of the dividend payments of all the ranked securities. In an embodiment, creating an index fund may include automatically purchasing each security in the subset in an amount so that each security's percentage value in the index fund corresponds to the determined weight for that security.

In an embodiment, after a time period, a new set of candidate securities may be selected wherein each candidate security in the new set has a quality rating that meets or exceeds a then-current quality rating threshold. A computer-generated rank may be assigned to each of the candidate securities in the new set. The rank may be based on each security's then-current dividend payment. The candidate securities in the new set may be ranked from highest to lowest. An updated subset of the highest ranked candidate securities may be automatically selected in the new set. Each security in the updated subset may be weighted by dividing a then-current dividend payment for each security by a then-current dividend payment for all of the securities in the updated subset. The index fund may be balanced to match the weight for each security in the updated subset. In an embodiment balancing the index fund may include automatically buying securities for the index fund to match the weight for each security in the updated subset. In an embodiment, balancing the index fund may include automatically selling securities in the index fund to match the weight for each security in the updated subset.

In an embodiment, the rating of the security may be obtained from a third party rating agency. In an embodiment, a security may include at least one of the following: a stock, a bond and a money market instrument. Weighting each security in the subset may include determining a percentage for each security in the index fund by multiplying the weight of each security by 100.

In an embodiment, a method of creating an index fund may include selecting, via a computing device, a plurality of candidate securities. Each candidate security may have a rating that meets or exceeds a quality rating threshold. A dividend payment may be accessed for each candidate security. A computer-generated rank of each of the candidate securities may be assigned. The rank may be based on the dividend payment for each candidate security. The candidate securities may be ranked from highest to lowest. A subset comprising the highest ranked candidate securities may be automatically selected. A computer-generated weight for each security in the subset may be determined by dividing the dividend payment for each security by a total dividend payment for all of the securities in the subset. An index fund may be created including the weighted securities. Alter a time period, a new computer-generated weight for each security in the subset may be determined by dividing each security's then-current dividend payment by a total then-current dividend payment for all of the securities in the subset. The index fund may be rebalanced to match the new weight for each security.

In an embodiment, rebalancing may include automatically buying and/or selling the securities in accordance with the new computer-generated weights. The total dividend payment may include a sum of the dividend payments of all the ranked securities. Creating an index fund may include automatically purchasing each security in the subset in an amount so that each security's percentage value in the index fund corresponds to the determined weight for that security.

In an embodiment, a system may include a storage medium that may contain information about a plurality of candidate securities and a computer processor in communication with the storage medium. The computer processor may be configured to select a plurality of the candidate securities based on a quality rating, access a dividend payment for each selected candidate security, automatically assign a rank to each of the selected candidate securities, select a subset of the highest ranked selected candidate securities, determine a computer-generated weight for each security in the subset, and create an index fund comprising the weighted securities. In an embodiment, a data source in communication with the computer processor, wherein the data source contains updated information about the securities.

### BRIEF DESCRIPTION OF THE DRAWINGS

FIG. 1 depicts an exemplary system for constructing an index fund according to an embodiment.

FIG. 2 depicts an exemplary flowchart of a method of creating an index fund according to an embodiment.

FIG. 3 depicts exemplary variables that may be considered when designing an index fund according to an embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

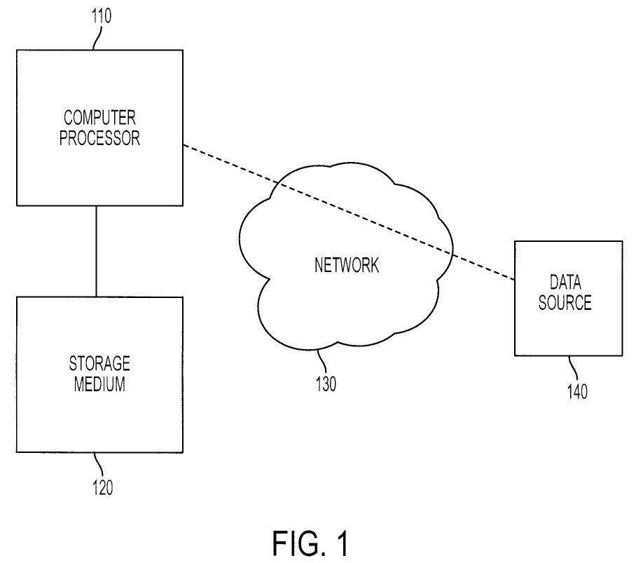

FIG. 1 depicts an exemplary embodiment of a system for constructing an index fund. The system includes a computer processor 110 and a computer readable storage medium 120. A storage medium may be any repository of searchable data, such as a computer-readable memory, database, table or other medium. The data in the storage medium includes information about multiple securities, such as stocks, bonds, mutual funds and other tradable securities. Information includes, but is not limited to, dividend payments. The storage medium is part of or communicates with a computer processor 110. The storage medium 120 may be contained within or separate from the computer processor 110. A computer processor 110 may be any type of computing device such as, but not limited to, a server, a personal computer, a personal digital assistant, a web-enabled phone, a gaming system, a smart terminal, a dumb terminal and/or another electronic device capable of communicating in a networked environment. Information in the storage medium may be automatically updated by accessing one or more data sources 140, such as online rating services, stock reporting services or other sources, via a network 130 such as a local area network (LAN), wide area network (WAN), Internet or another communications network.

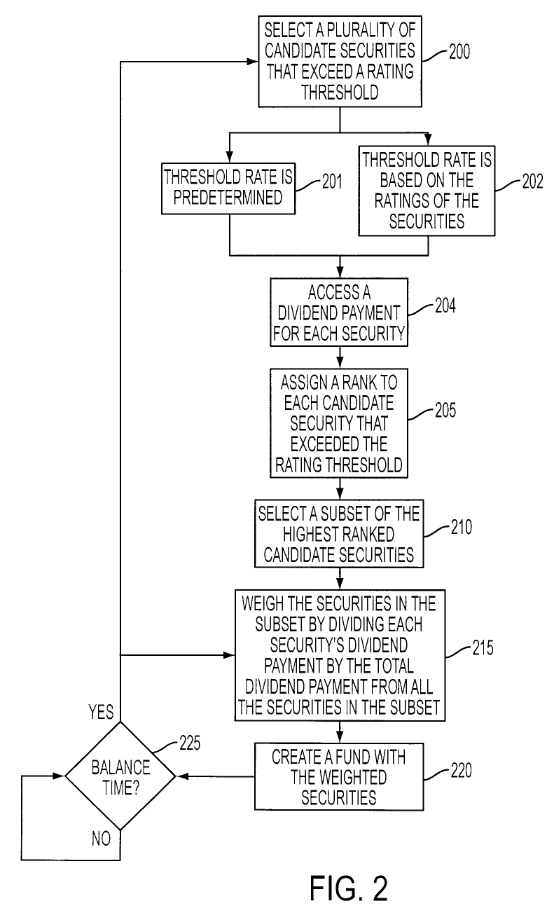

FIG. 2 discloses an exemplary method of creating an index fund according to an embodiment. An index fund is a collective investment that receives money from multiple investors and invests that money in a plurality of securities. A security is a fungible, negotiable interest which represents a financial value. Securities may include, but are not limited to, stocks, bonds and/or money market instruments. A fund manager trades the securities in the fund, and gains or losses from the trades are passed along to the fund's investors. Some funds may be actively managed such that the fund manager subjectively selects the securities and decides when to buy and sell them. Other funds, such as index funds, undergo passive management. In an index fund, securities are bought and sold in accordance with a constant set of rules.

According to FIG. 2, a computer processor may automatically select a plurality of candidate securities for potential inclusion in an index fund. In an embodiment, a criterion for potential inclusion may be whether each security's rating meets or exceeds a threshold quality rating 200.

The storage medium includes several information elements corresponding to each candidate security. In an embodiment, the information about a security includes a quality rating. A quality rating is a value representative of the financial strength, stability and level of risk exposure of a company. A quality rating also may predict the ability of a security to rise in value. In an embodiment, a quality rating may be assigned by an entity who has researched financial performance of the security. Such an entity may include, but is not limited to, a financial services company such as Standard and Poors (S&P), Value Line, Fitch Ratings, Ltd., Morningstar and Moody's Corporation. For example, S&P is a financial services company which rates securities on various criteria, such as credit ratings for the debt of companies and earnings and dividend ranking systems for common stocks.

A security's quality rating may include, but is not limited to, a symbol, a number and/or a letter. In an embodiment, there may be a highest possible quality rating and a lowest possible quality rating. For example, a quality rating may be a score of 1 to 100 with 1 as the lowest and 100 as the highest. In another example, a quality rating may be a number with A as the highest and D at the lowest. In an embodiment, there may be a symbol in addition to a number for the quality rating. For example, A+ may be a higher rating than A.

In an embodiment, each candidate security will have a quality rating. In an embodiment, multiple securities may have the same quality rating. For example, Security A and Security B may both have a quality rating of A+. Alternatively, each security may have a different quality rating. In an embodiment, the quality rating may be a current value. Alternatively, the quality rating may be determined by examining the financial strength, stability and/or performance of the stock over a set period. In an embodiment, the quality rating may be the average quality ratings of a security over a set period. The set period may be based on how often the ratings are released. The set period may be, but is not limited to, every few years, once a year, every six months or some other time interval.

The securities which have a quality rating that meets or exceeds a quality rating threshold may be automatically selected as candidates for potential inclusion in the index fund. Optionally, there may be several ways in which a quality rating threshold may be determined. In Option A, the threshold quality rating may be a predetermined value 201. Alternatively, in Option B, the threshold quality rating may be determined based on the range of quality ratings of the securities 202. For example, if there are 300 securities, the subset may be ideally between 100 and 200. Therefore, based on how the quality ratings are spread or divided, a threshold quality rating may be automatically chosen. For example, the quality ratings may be A, B, C and D with 5 securities rated A, 150 securities rated B, 100 securities rated C, and 45 securities rated D. Therefore, in that scenario, the threshold quality rating may be automatically determined to be B as using rankings A and B form a subset of 155 securities. However, in another example, 20 securities are rated A, 45 securities are rated B, 35 securities are rated C, and 200 securities are rated D. Therefore, the quality rating threshold may be automatically determined to be C so that 100 securities are included in subset to form the index fund.

After the candidate securities which meet or exceed the quality rating threshold are automatically selected, a dividend payment for each security may be automatically accessed 204. The dividend payment may be information automatically stored in the storage medium that is obtained from the data source. The dividend payment may be the latest quarterly or annual dividend paid by the security issuer, or it may reflect total or average dividend payments over a set period. The dividend payment may be considered over, but are not limited to, a quarterly, semiannual, annual or another period of time. A dividend payment may be determined based upon a dividend per share value. In an embodiment, a total dividend payment corresponding to all outstanding shares may be automatically determined.

The candidate securities may then be automatically ranked 205. Each candidate security may be ranked based on the dividend payment for that security. In an embodiment, the candidate securities may be assigned a computer-generated rank. For example, the candidate security having the highest dividend payment may be ranked first and that candidate security having the lowest dividend payment may be ranked last. In an embodiment, the dividends may be ranked based on stability or other criteria.

After each security is assigned a computer-generated rank based on dividend payment, a subset of the highest ranked candidate securities may be automatically selected 210 for inclusion in the index fund. In an embodiment, the subset may include a set or predetermined number of securities. For example, the subset may include the 250 candidate securities having the highest rank, the 500 candidate securities having the highest rank or any alternate number may be used. In an embodiment, other criteria may be used to select the ranked securities for inclusion in the subset. In an embodiment, the subset may include all securities with dividend payments above a certain dividend payment threshold. For example, there may be 200 ranked securities, of which securities 1 through 125 have a dividend payment that meets or exceeds a predetermined dividend payment threshold. Therefore, the subset may include the 125 securities that meet or exceed the divided payment threshold by automatically comparing each security with the predetermined divided payment threshold.

In an embodiment, all of the securities in the subset may be included in the index fund. However, the money placed into a fund must be divided among the different securities. To determine a percentage allocated to each security in the index fund, the securities may be automatically weighted. A computer-generated weight may be determined for each security. Each security in the subset may be weighted by dividing that security's dividend payment by the total dividend payment 215 for all the securities in the subset. The total dividend payment includes the sum of all the dividend payments of all the securities in the subset. For example, if the total dividend payment for the subset was $200 and the dividend payment for a first security was $10, then the weight for that first security would be 10/200 or 0.05. Alternatively, if the dividend payment for a second security is $50, then the weight for a second security would be 50/200 or 0.25. The percentage may be determined by multiplying the weight by 100. The percentage of each security is the amount that the security will be represented in the index fund on a percentage basis.

An index fund may be created by automatically purchasing securities in amounts corresponding to each security's calculated weight 220. For example, using the weights listed above, a fund having one million dollars to invest may include 5% ($50,000) of the first security and 25% ($250,000) of the second security. If exact percentages are not possible, approximate percentages may be used.

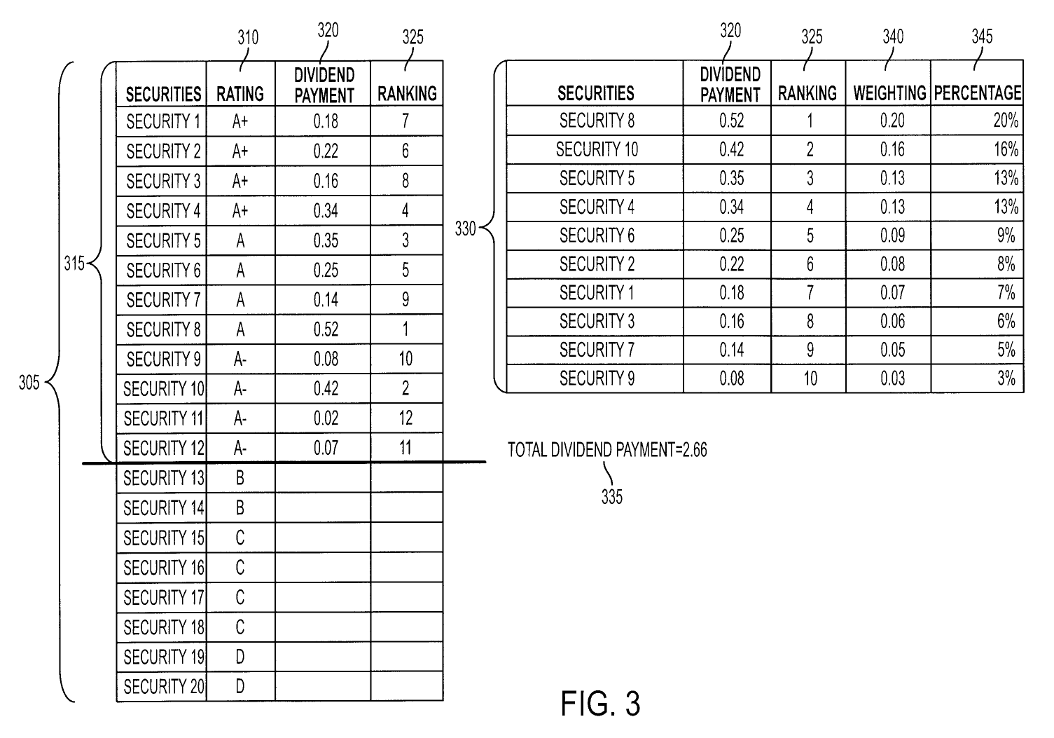

FIG. 3 depicts exemplary variables that may be used when creating an index fund according to an embodiment. In a list of 20 securities 305, each security may have a quality rating 310. A plurality of securities that meet or exceed a quality rating threshold may be automatically selected. The quality rating threshold may be “A-minus.” Therefore, only securities meeting or exceeding that rating (i.e., securities rated A+, A or A−) may be automatically selected. From the selected securities 315, the dividend payment 320 for one share over the past quarter may be automatically determined. The securities may be automatically ranked 325 by their dividend amount. After the securities are ranked 325, a subset 330 of the highest ranked securities may be automatically selected. For example, in FIG. 3, the subset 330 was the ten highest ranked securities. These ten securities will be automatically selected for use in the index fund.

To determine the percentage of each security in the index fund, each security may be weighted. The weighting may be determined by dividing each security's dividend payment by the total dividend amount for all securities in the index fund. The total dividend payment 335 may be automatically determined by adding together all the securities dividend payments in the subset 330. The total dividend payment 335 is $2.66. The computer-generated weight for each security may be automatically determined by dividing that security's dividend payment by $2.66 (the total dividend payment). For example, Security 8 is ranked first so it will have the highest weighting. The weighting of Security 8 will be automatically determined by dividing 0.52 by 2.66. The weight is 0.20. After every security in the subset 330 is weighted, the weight may be multiplied by 100 to determine each security's percentage 345 in the index fund. Therefore, the index fund will have 20% Security 8, 16% Security 10, 13% Security 5, 13% Security 4, 9% Security 6, 8% Security 2, 7% Security 1, 6% Security 2, 5% Security 7 and 3% Security 9.

In an alternate embodiment, securities may be weighted by different criteria once placed into the subset. For example, the securities may be weighted by net income, market cap or revenue.

Referring back to FIG. 2, after an index fund is initially created, the index fund may be automatically rebalanced 225. Rebalancing an index fund means automatically buying and/or selling the securities in the fund to reflect changes in the information elements (such as rating and dividend payment) over time. An index fund may be automatically rebalanced after a time period on a periodic basis such as, but not limited to, quarterly, semiannually, annually or another time period. Alternatively, the index fund may be rebalanced at time periods which are random intervals. If the index fund is automatically rebalanced 225, then there are two options for rebalancing. In Option A, the index fund may be automatically rebalanced when new dividend payments are provided. As a result of the new dividend payments, the securities may have new computer-generated weights. The index fund may be automatically rebalanced by buying and selling amounts of the securities to match the new weighted securities for the fund 225. In Option B, new securities may be automatically selected based on new quality ratings or a new quality rating threshold. If the securities have new quality ratings, a new set of candidate securities may be automatically selected based on the quality rating threshold. Ranks and weights for the new candidate securities may be automatically determined based on dividends. The index fund may be automatically rebalanced by buying and/or selling securities to match the new weighted securities for the fund.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of creating an index fund, the method comprising:
selecting, via a computing device, a plurality of candidate securities, wherein each candidate security has a quality rating that meets or exceeds a rating threshold;
accessing a dividend payment for each candidate security;
automatically assigning a computer-generated rank to each of the candidate securities, wherein the rank is based on the dividend payment for each candidate security, and wherein the candidate securities are ranked from highest to lowest;
selecting a subset comprising the highest ranked candidate securities;
determining a computer-generated weight for each security in the subset by dividing the dividend payment for each security by a total dividend payment for all of the securities in the subset; and
creating an index fund comprising the weighted securities.

2. The method of claim 1, further comprising:
after a time period, automatically determining a new computer-generated weight for each security in the subset by dividing each security's then-current dividend payment by a total then-current dividend payment for all of the securities in the subset; and
rebalancing the index fund to match the new weight for each security.

3. The method of claim 2 wherein rebalancing comprises:
automatically buying the securities in accordance with the new weights.

4. The method of claim 2 wherein rebalancing comprises:
automatically selling the securities in accordance with the new weights.

5. The method of claim 1 wherein the total dividend payment comprises a sum of the dividend payments of all the ranked securities.

6. The method of claim 1 wherein creating an index fund comprises:
automatically purchasing each security in the subset in an amount so that each security's percentage value in the index fund corresponds to the determined weight for that security.

7. The method of claim 1, further comprising:
after a time period, selecting a new set of candidate securities, wherein each candidate security in the new set has a quality rating that meets or exceeds a then-current quality rating threshold;
assigning a computer-generated rank to each of the candidate securities in the new set, wherein the rank is based on each security's then-current dividend payment, and wherein the candidate securities in the new set are ranked from highest to lowest;
automatically selecting an updated subset of the highest ranked candidate securities in the new set;
weighting each security in the updated subset by dividing a then-current dividend payment for each security by a then-current dividend payment Nor all of the securities in the updated subset; and
balancing the index fund to match the weight for each security in the updated subset.

8. The method of claim 7 wherein balancing the index fund comprises:
automatically buying securities for the index fund to match the weight for each security in the updated subset.

9. The method of claim 7 wherein balancing the index fund comprises:
automatically selling securities in the index fund to match the weight for each security in the updated subset.

10. The method of claim 1, further comprising:
obtaining the rating of the security from a third party rating agency.

11. The method of claim 1 wherein a security comprises at least one of the following: a stock, a bond and a money market instrument.

12. The method of claim 1 wherein weighting each security in the subset comprises:
determining a percentage for each security in the index fund by multiplying the weight of each security by 100.

13. A method of creating an index fund, the method comprising:
selecting, via a computing device, a plurality of candidate securities, wherein each candidate security has a rating that meets or exceeds a quality rating threshold;
accessing a dividend payment for each candidate security;
assigning a computer-generated rank to each of the candidate securities, wherein the rank is based on the dividend payment for each candidate security, and wherein the candidate securities are ranked from highest to lowest;
automatically selecting a subset comprising the highest ranked candidate securities;
determining a computer-generated weight for each security in the subset by dividing the dividend payment for each security by a total dividend payment for all of the securities in the subset;
creating an index fund comprising the weighted securities;
after a time period, determining a new computer-generated weight for each security in the subset by dividing each security's then-current dividend payment by a total then-current dividend payment for all of the securities in the subset; and
rebalancing the index fund to match the new weight for each security.

14. The method of claim 13 wherein rebalancing comprises:
automatically buying the securities in accordance with the new weights.

15. The method of claim 13 wherein rebalancing comprises:
automatically selling the securities in accordance with the new weights.

16. The method of claim 13 wherein the total dividend payment comprises a sum of the dividend payments of all the ranked securities.

17. The method of claim 13 wherein creating an index fund comprises:
automatically purchasing each security in the subset in an amount so that each security's percentage value in the index fund corresponds to the determined weight for that security.

18. A system comprising:
a storage medium that contains information about a plurality of candidate securities; and
a computer processor in communication with the storage medium, wherein the computer processor is configured to select a plurality of the candidate securities based on a quality rating, access a dividend payment for each selected candidate security, automatically assign a rank to each of the selected candidate securities, select a subset of the highest ranked selected candidate securities, determine a computer-generated weight for each security in the subset, and create an index fund comprising the weighted securities.

19. The system of claim 18, further comprising:
a data source in communication with the computer processor, wherein the data source contains updated information about the securities.
